(19) United States
(12) Patent Application Publication
(10) Pub. No.: US 2019/0366519 A1
(43) Pub. Date: Dec. 5, 2019

(54) Torque Wrench

(71) Applicant: Plus Craft Industrial Co., Ltd., Taichung City (TW)

(72) Inventor: Timmy Chen, Taichung City (TW)

(21) Appl. No.: 15/990,955

(22) Filed: May 29, 2018

(51) Int. Cl. B25B 23/142

(52) U.S. Cl. CPC B25B 23/1427

(57) ABSTRACT

A torque wrench includes an outer tube, a torque adjusting unit mounted on the outer tube, and a driving head mounted on the outer tube. The outer tube is provided with an elongate slot. A handle is mounted on a first end of the outer tube. The torque adjusting unit includes a support rod mounted in the outer tube, a sliding sleeve slidably mounted on the support rod, and a click alarm mechanism mounted on a top of the support rod. The support rod is provided with a plurality of limit screw holes. The driving head is mounted on a second end of the outer tube and provided with a pivot portion pivotally mounted in the outer tube. The pivot portion is formed with a mounting lever which has a distal end pivotally connected with the click alarm mechanism.

### BACKGROUND OF THE INVENTION

### 1. Field of the Invention

The present invention relates to a hand tool and, more particularly, to a torque wrench.

### 2. Description of the Related Art

A torque wrench is used for operating and applying a torque on a workpiece, such as a bolt, screw, nut or the like. The torque applied by the torque wrench has an upper limit that is preset to prevent the workpiece from being worn out or broken due to an excessive force. A conventional torque wrench in accordance with the prior art shown in FIGS. 1 and 2 comprises a handle 11, a socket wrench 1 mounted on an end of the handle 11, a click alarm mechanism 12 mounted in the handle 11, an adjusting base 14 mounted in the handle 11, and a compression spring 13 mounted in the handle 11 and biased between the click alarm mechanism 12 and the adjusting base 14. The handle 11 has a surface provided with multiple torque indication numbers 15. The adjusting base 14 is located at a predetermined position, to push the compression spring 13 which applies a pressure on the click alarm mechanism 12 to reach the torque value set for the socket wrench 1. Thus, the relative position of the adjusting base 14 is changed to adjust the pressure applied on the compression spring 13, so as to adjust the torque value of the socket wrench 1. The torque indication numbers 15 help the operator identify the different torque values of the socket wrench 1. The handle 11 is rotated relative to the socket wrench 1 to align with one of the torque indication numbers 15, so as to reach the required torque value. When the socket wrench 1 applies a force on the workpiece to reach the set torque value (when the torque is greater than the set pressure for the compression spring 13), the click alarm mechanism 36 is released and sounds “click” alarm to remind the operator. However, when the torque wrench is used for operating workpieces of different specifications and torques, the operator has to rotate the handle 11 frequently, thereby causing inconvenience to the operator. In addition, the operator has to manually identify different torque values of the socket wrench 1 by the torque indication numbers 15, so that when the operator makes mistakes, the workpiece is easily worn out or broken due to an excessive force.

### BRIEF SUMMARY OF THE INVENTION

The primary objective of the present invention is to provide a torque wrench that easily adjusts the force arm of a moment so as to provide a fixed torque with different torque values.

In accordance with the present invention, there is provided a torque wrench comprising an outer tube, a torque adjusting unit mounted on the outer tube, and a driving head mounted on the outer tube. The outer tube is provided with an elongate slot. A handle is mounted on a first end of the outer tube. The torque adjusting unit includes a support rod mounted in the outer tube, a sliding sleeve slidably mounted on the support rod, and a click alarm mechanism mounted on a top of the support rod. The support rod is provided with a plurality of limit screw holes arranged longitudinally. The driving head is mounted on a second end of the outer tube and provided with a pivot portion pivotally mounted in the outer tube. The pivot portion of the driving head is integrally formed with a mounting lever. The mounting lever has a distal end pivotally connected with the click alarm mechanism of the torque adjusting unit.

According to the primary advantage of the present invention, the sliding sleeve corresponds to any one of the limit screw holes of the support rod and is located at different positions, to change the length of the force arm and the driving force, so that the torque tolerated by the driving head is changed, so as to satisfy the requirement of different torque values of the driving head.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional torque wrench in accordance with the prior art.

FIG. 2 is a cross-sectional view of the conventional torque wrench in accordance with the prior art.

FIG. 3 is a perspective view of a torque wrench in accordance with the preferred embodiment of the present invention.

FIG. 4 is an exploded perspective view of the torque wrench in accordance with the preferred embodiment of the present invention.

FIG. 5 is a cross-sectional view of the torque wrench in accordance with the preferred embodiment of the present invention.

FIG. 6 is a schematic operational view of the torque wrench as shown in FIG. 5 in use.

FIG. 7 is a schematic operational view of the torque wrench as shown in FIG. 6 in adjustment.

FIG. 8 is a schematic operational view of the torque wrench as shown in FIG. 7 in adjustment.

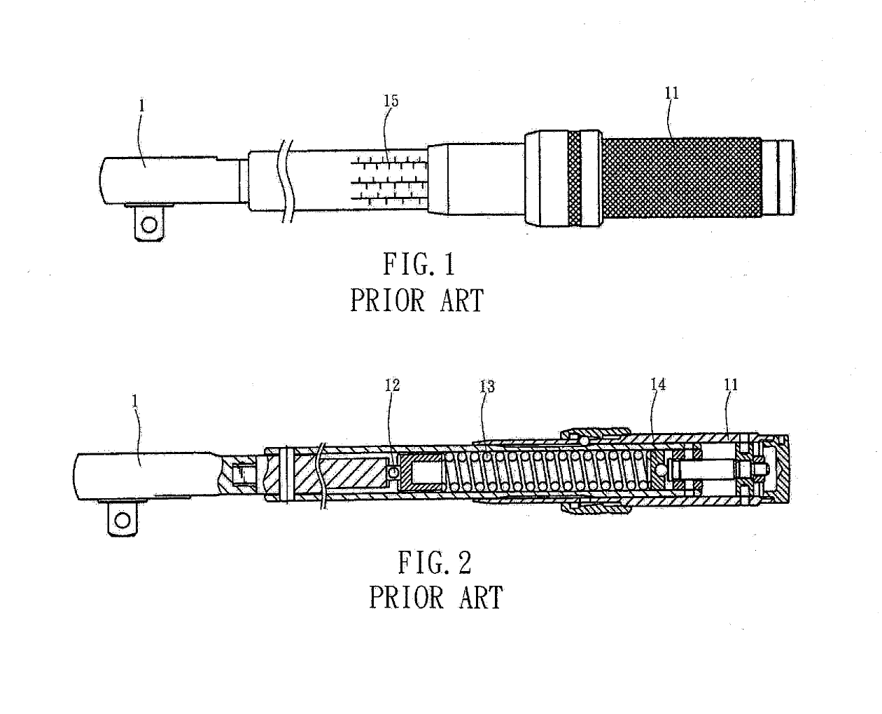

### DETAILED DESCRIPTION OF THE INVENTION

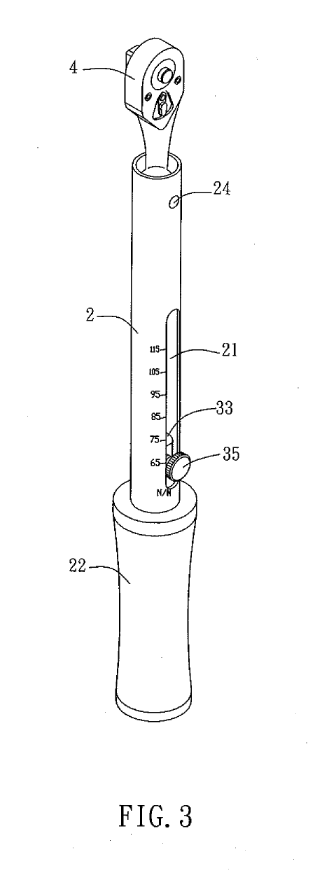

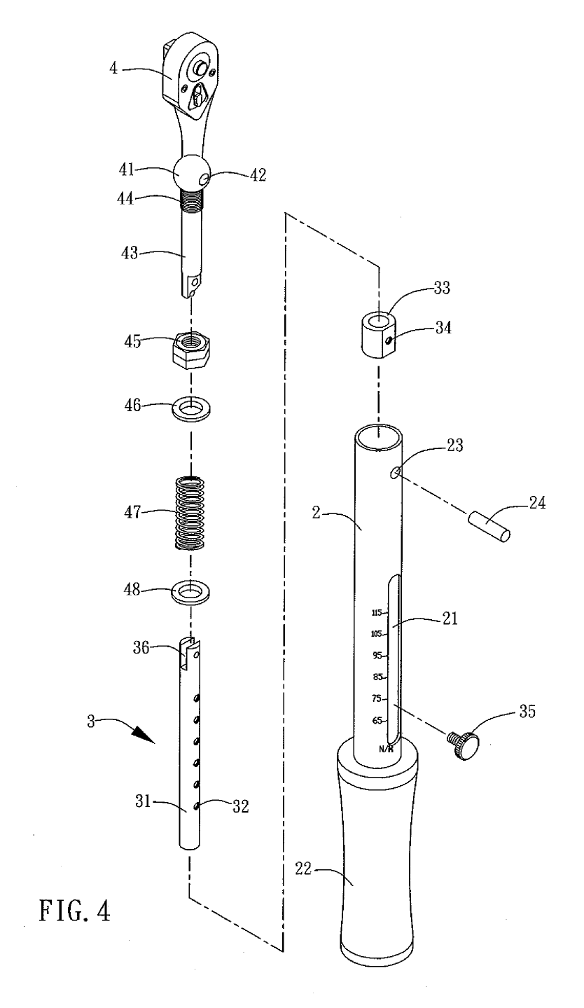

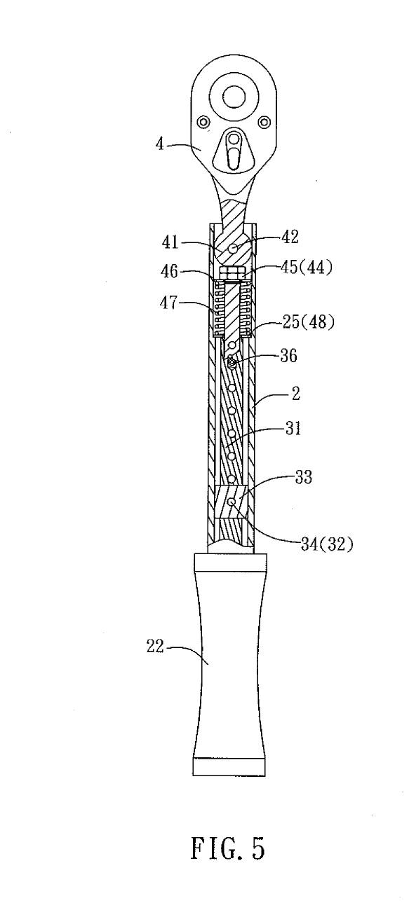

Referring to the drawings and initially to FIGS. 3-5, a torque wrench in accordance with the preferred embodiment of the present invention comprises an outer tube 2, a torque (or moment) adjusting unit 3 mounted on the outer tube 2, and a driving head 4 mounted on the outer tube 2.

The outer tube 2 has a hollow interior and is provided with an elongate slot 21. The elongate slot 21 of the outer tube 2 is provided with a plurality of indication scales with a unit of Newton per meter (NIM) of an, international standard. A handle 22 is mounted on a first end of the outer tube 2.

The torque adjusting unit 3 includes a support rod 31 mounted in the outer tube 2, a sliding sleeve 33 slidably mounted on an outer diameter of the support rod 31, and a click alarm mechanism 36 mounted on a top of the support rod 31. The support rod 31 is provided with a plurality of limit screw holes 32 arranged longitudinally.

The driving head 4 is mounted on a second end of the outer tube 2. The driving head 4 is provided with a pivot portion 41 pivotally mounted in the outer tube 2. The pivot portion 41 of the driving head 4 is integrally formed with a mounting lever 43 which is located under the pivot portion 41. The mounting lever 43 has a distal end pivotally connected with the click alarm mechanism 36 of the torque adjusting unit 3. Preferably, the driving head 4 is a socket wrench.

In the preferred embodiment of the present invention, the second end of the outer tube 2 is provided with a first through hole 23, the pivot portion 41 of the driving head 4 is provided with a second through hole 42, and a shaft 24 extends through the first through hole 23 of the outer tube 2 and the second through hole 42 of the pivot portion 41, so that the driving head 4 is pivotally connected with the outer tube 2.

In the preferred embodiment of the present invention, the sliding sleeve 33 of the torque adjusting unit 3 is mounted in the outer tube 2 and has an outer diameter smaller than an inner diameter of the outer tube 2. The sliding sleeve 33 of the torque adjusting unit 3 is limited by the support rod 31 and is movable upward and downward in the outer tube 2 to adjust a position thereof.

In the preferred embodiment of the present invention, the driving head 4 is provided with a threaded section 44 located at a connection of the pivot portion 41 and the mounting lever 43. A nut 45 is screwed onto the threaded section 44 for adjustment of a torque value of the torque wrench. A first washer 46 is mounted on the mounting lever 43 and located under the nut 45. A second washer 48 is mounted on the mounting lever 43 and located under the first washer 46. A compression spring 47 is mounted on the mounting lever 43 and biased between the first washer 46 and the second washer 48. The outer tube 2 has an interior provided with a stepped edge 25, and the second washer 48 rests on the stepped edge 25 of the outer tube 2. The nut 45 is moved axially relative to the threaded section 44 by rotation to change the position of the nut 45, so as to adjust the pressure applied on the compression spring 47 and to regulate the torque value of the torque wrench.

In the preferred embodiment of the present invention, the sliding sleeve 33 of the torque adjusting unit 3 is provided with a transverse screw bore 34, and a threaded knob 35 is screwed through the screw bore 34 of the sliding sleeve 33 and is screwed into one of the limit screw holes 32 of the support rod 31. The threaded knob 35 is movable in the elongate slot 21 of the outer tube 2.

In assembly, the sliding sleeve 33 is mounted on the support rod 31. Then, the nut 45 is screwed onto the threaded section 44. Subsequently, the first washer 46, the compression spring 47 and the second washer 48 are in turn mounted on the mounting lever 43. Then, the distal end of the mounting lever 43 is pivotally mounted in the click alarm mechanism 36 of the torque adjusting unit 3. Then, the support rod 31 and the mounting lever 43 are mounted in the outer tube 2, with the second washer 48 resting on the stepped edge 25 of the outer tube 2. Then, the shaft 24 extends through the first through hole 23 of the outer tube 2 and the second through hole 42 of the pivot portion 41, so that the driving head 4 is pivotally connected with the outer tube 2. Then, the threaded knob 35 is screwed through the screw bore 34 of the sliding sleeve 33 and screwed into one of the limit screw holes 32 of the support rod 31 to position the sliding sleeve 33 on the support rod 31.

In practice, the equation of the torque is listed as follow:

L=D×F, wherein (L) indicates the torque, (D) indicates the length of the force arm, and (F) indicates the driving force.

The sliding sleeve 33 functions as a fulcrum, and the length (D) of the force arm is equal to the distance between one of the limit screw holes 32 of the support rod 31 and the click alarm mechanism 36. When the nut 45 is screwed onto the threaded section 44, the pressure applied on the compression spring 47 is set, so that the torque (L) of the driving head 4 is set and has a fixed value. In such a manner, when the torque (L) of the driving head 4 reaches the set value (that is, the torque is greater than the set pressure applied on the compression spring 47), the click alarm mechanism 36 is released and sounds “click” alarm to remind the operator. The operation of the click alarm mechanism 36 is traditional and will not be further described in detail.

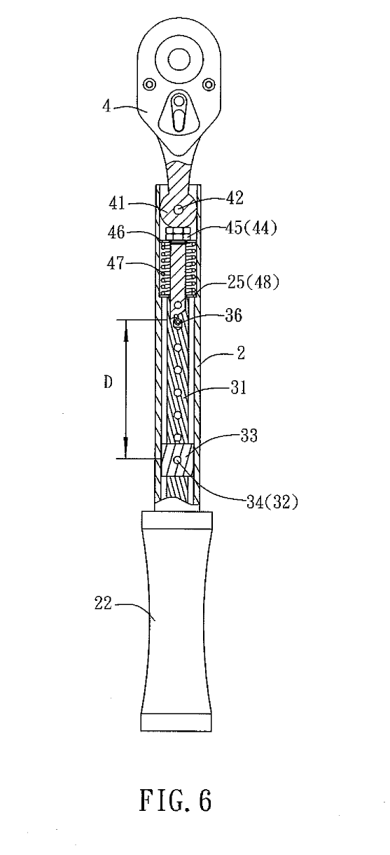

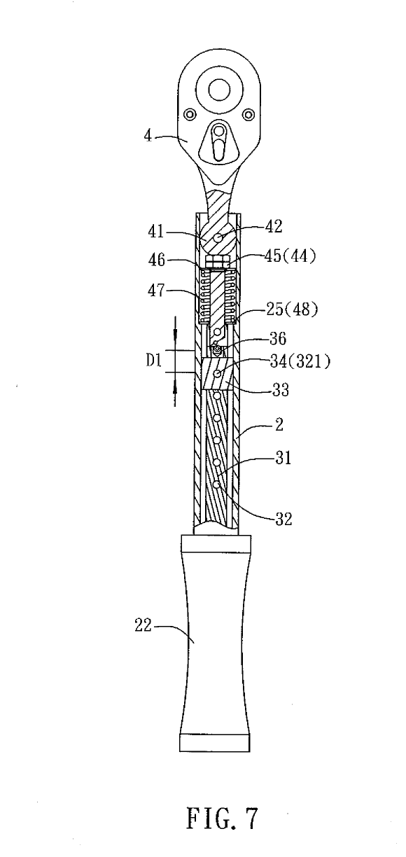

In operation, referring to FIGS. 6 and 7 with reference to FIGS. 3-5, when the threaded knob 35 is screwed into a first limit screw hole 32 of the support rod 31, the first length of the force arm is equal to (D) as shown in FIG. 6, and the first driving force is equal to (F). When the threaded knob 35 is screwed into a second limit screw hole 321 of the support rod 31, the second length of the force arm is equal to (D1) as shown in FIG. 7, and the second driving force is equal to (F1). At this time, the torque (L) of the driving head 4 is set and has a fixed value, so that L=D×F=D1×F1. When D1 is smaller than D, F1 is greater than F, that is, when the length of the force arm is decreased, the driving force is increased. On the contrary, when the length of the force arm is increased, the driving force is decreased. Thus, the maximum value of the driving force applied by the operator is adjusted by changing the length of the force arm. In short, when the length of the force arm is longer, the driving force is smaller to reach the click alarm action of the click alarm mechanism 36, so that the driving head 4 tolerates a smaller torque, and when the length of the force arm is shorter, the driving force is larger to reach the click alarm action of the click alarm mechanism 36, so that the driving head 4 tolerates a greater torque.

In conclusion, the threaded knob 35 (or the sliding sleeve 33) is located at different positions to correspond to any one of the limit screw holes 32 of the support rod 31, so as to change the length of the force arm and the driving force, so that the torque tolerated by the driving head 4 is changed, so as to satisfy the requirement of different torque values of the driving head 4. In addition, the torque value of the driving head 4 is adjusted exactly and precisely by displacing the sliding sleeve 33, without having to adjust the position of the compression spring 47, thereby facilitating the operator adjusting the torque value of the driving head 4.

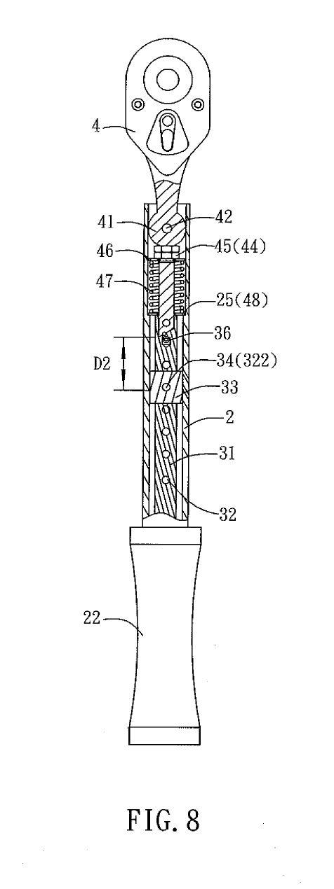

Referring to FIG. 8 with reference to FIGS. 3-7, the threaded knob 35 is unscrewed from the first limit screw hole 32 of the support rod 31, and is moved upward to move the sliding sleeve 33 upward. When the threaded knob 35 (or the sliding sleeve 33) is moved to the required position, the threaded knob 35 is screwed into a third limit screw hole 322 of the support rod 31, so that the threaded knob 35 (or the sliding sleeve 33) is locked onto the support rod 31 again. Thus, the length (D2) of the force arm is adjusted easily and quickly, so as to change the torque value of the driving head 4.

Accordingly, the sliding sleeve 33 corresponds to any one of the limit screw holes 32 of the support rod 31 and is located at different positions, to change the length of the force arm and the driving force, so that the torque tolerated by the driving head 4 is changed, so as to satisfy the requirement of different torque values of the driving head 4.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A torque wrench comprising:
an outer tube;
a torque adjusting unit mounted on the outer tube; and
a driving head mounted on the outer tube;
wherein:
the outer tube is provided with an elongate slot;
a handle is mounted on a first end of the outer tube;
the torque adjusting unit includes a support rod mounted in the outer tube, a sliding sleeve slidably mounted on the support rod, and a click alarm mechanism mounted on a top of the support rod;
the support rod is provided with a plurality of limit screw holes arranged longitudinally;
the driving head is mounted on a second end of the outer tube and provided with a pivot portion pivotally mounted in the outer tube;
the pivot portion of the driving head is integrally formed with a mounting lever; and
the mounting lever has a distal end pivotally connected with the click alarm mechanism of the torque adjusting unit.

2. The torque wrench of claim 1, wherein the second end of the outer tube is provided with a first through hole, the pivot portion of the driving head is provided with a second through hole, and a shaft extends through the first through hole of the outer tube and the second through hole of the pivot portion, so that the driving head is pivotally connected with the outer tube.

3. The torque wrench of claim 1, wherein:
the sliding sleeve of the torque adjusting unit is mounted in the outer tube and has an outer diameter smaller than an inner diameter of the outer tube; and
the sliding sleeve of the torque adjusting unit is limited by the support rod and is movable upward and downward in the outer tube.

4. The torque wrench of claim 1, wherein:
the driving head is provided with a threaded section located at a connection of the pivot portion and the mounting lever;
a nut is screwed onto the threaded section;
a first washer is mounted on the mounting lever and located under the nut;
a second washer is mounted on the mounting lever and located under the first washer;
a compression spring is mounted on the mounting lever and biased between the first washer and the second washer;
the outer tube has an interior provided with a stepped edge; and
the second washer rests on the stepped edge of the outer tube.

5. The torque wrench of claim 1, wherein:
the sliding sleeve of the torque adjusting unit is provided with a transverse screw bore; and
a threaded knob is screwed through the screw bore of the sliding sleeve and is screwed into one of the limit screw holes of the support rod.
